(19) United States
(12) Patent Application Publication
(10) Pub. No.: US 2013/0064745 A1
(43) Pub. Date: Mar. 14, 2013

(54) FLUE GAS TREATMENT AND PERMEATE HARDENING

(71) Applicant: Boris Liberman, Even Yehuda (IL)

(72) Inventor: Boris Liberman, Even Yehuda (IL)

(73) Assignee: I.D.E. TECHNOLOGIES LTD., Kadima (IL)

(21) Appl. No.: 13/699,733

(22) PCT Filed: Jun. 2, 2011
(86) PCT No.: PCT/IB2011/052427

§ 371 Date: Nov. 25, 2012

Related U.S. Application Data
(60) Provisional application No. 61/350,930, filed on Jun. 3, 2010.

(51) Int. Cl. B01D 53/14; B01D 53/75; B01D 19/00; B01D 53/62

(52) U.S. Cl. 423/220; 422/169; 96/234; 96/235; 95/156; 95/186

(57) ABSTRACT

Combining flue gas treatment, and in particular CO₂ sequestration, with hardening of reverse osmosis (RO) permeate. Flue gas is compressed and injected into pressurized water, being either cooling water or RO permeate. The water with dissolved CO₂ is either dispensed into the sea for biological fixation of the CO₂ or, in the case of RO permeate, mixed with limestone to harden the product water.

### BACKGROUND

1. Technical Field

The present invention relates to flue gas treatment and water desalination more particularly, to a synergetic connection of a power plant and a desalination plant.

2. Discussion of the Related Art

FIG. 1 is a schematic illustration of a prior art system for treating flue gas and providing CO₂ to acidify product water (permeate) from a desalination plant, such as a reverse osmosis (RO) plant 130.

The prior art system comprises a power plant with CO₂ regenerator 61 followed by a stripper tower 62. Power plant 61 produces flue gas 81, including CO₂, N₂, O₂ and other gases. Some of the flue gas is processed in a cooler and scrubber unit 71 and in an absorber tower 72. For production of CO₂, flue gas 81 goes through a processing chain comprising KMnO₄ bubblers 64, a purification tower 65 and a CO₂ drying tower 66, to be finally condensed by a CO₂ condenser 67 and stored as a liquid in a liquid CO₂ container 68.

For acidifying RO product water, liquid CO₂ is mixed with the permeate, or CO₂ is bubbled into the permeate. The acidified permeate is then added limestone for hardening the water.

The process is an elaborate and expensive one.

### BRIEF SUMMARY

One aspect of the invention provides a system comprising: a compressor connected to a flue gas outlet of a plant and arranged to compress flue gas obtained therefrom to a specified pressure, the flue gas comprising CO₂, a water source supplying pressurized water, an absorber connected to the water source and arranged to spray water therefrom, further connected to the compressor and arranged to inject the compressed flue gas into the sprayed water to dissolve over 50% of CO₂ in the flue gas in the resulting water, and a water receiving unit connected to the absorber and arranged to receive the water with dissolved flue gas therefrom and to remove dissolved CO₂ from the resulting water into an organic or a mineralized form.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIGS. 2-4 are high level schematic block diagrams illustrating a system according to some embodiments of the invention, and

FIG. 5 is a high level flowchart illustrating a method according to some embodiments of the invention.

The drawings together with the following detailed description make apparent to those skilled in the art how the invention may be embodied in practice.

### DETAILED DESCRIPTION

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

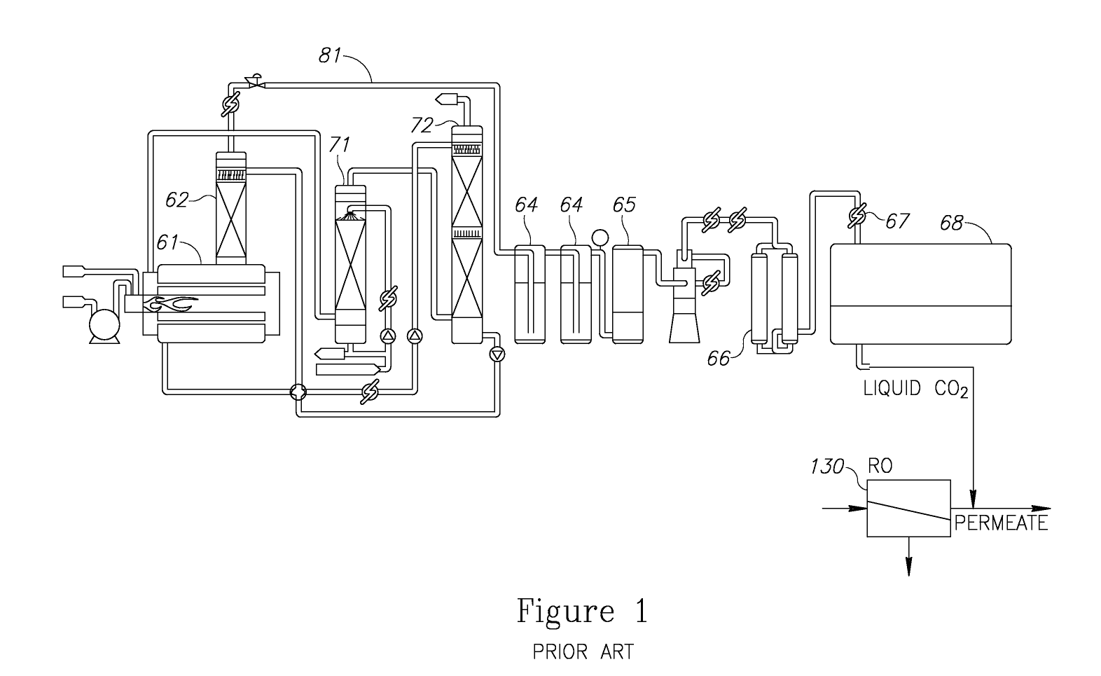

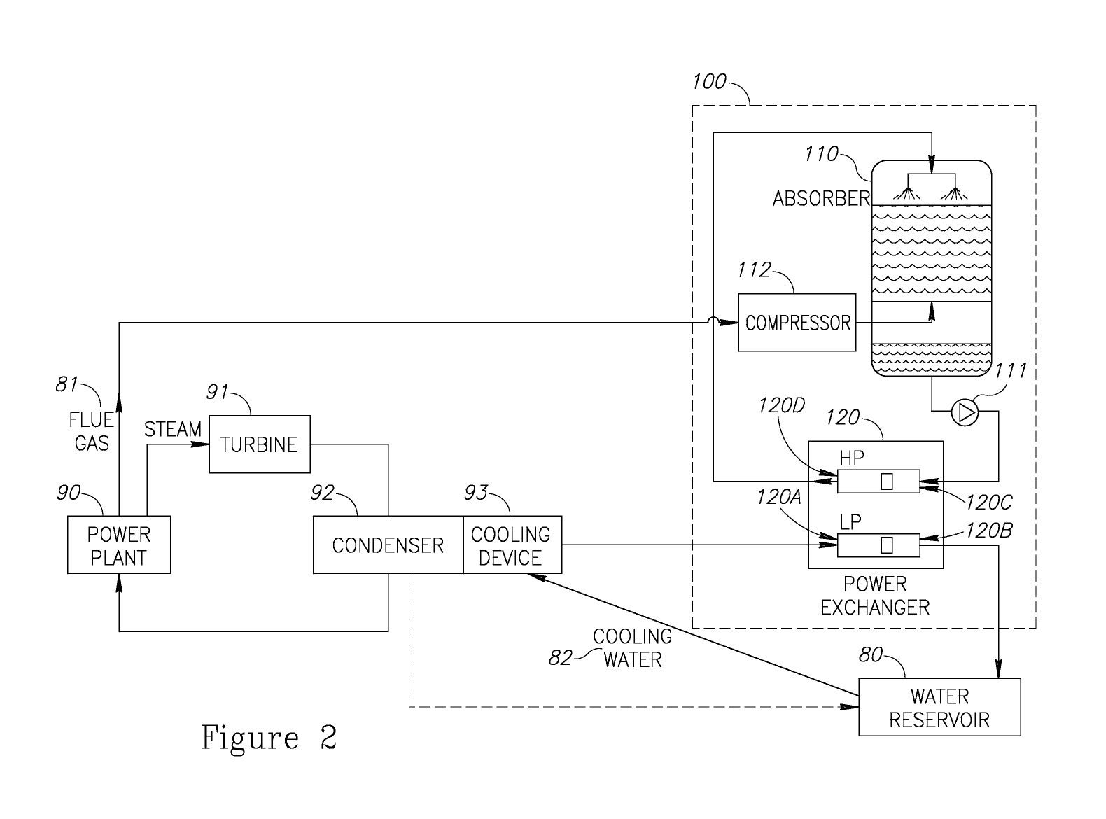

FIG. 2 is a high level schematic block diagram illustrating a system 100 according to some embodiments of the invention.

System 100 comprises a compressor 112, an absorber 110 and a water receiving unit (depicted in FIG. 2 as power exchanger 120 and water reservoir 80).

Compressor 112 is connected to a flue gas outlet of a plant 90 and is arranged to compress flue gas 81 obtained therefrom to a specified pressure e.g. 20 bar that allows dissolving flue gas 81 into water sprayed in absorber 110. Flue gas 81 comprises CO₂, N₂, O₂ and other gases.

Absorber 110 is connected to a water source that supplies pressurized water (e.g. at 20 bar). The water source may comprise pumped seawater serving as cooling water 82 in power plant 90, as illustrated in FIG. 2. Pressurization of the water supplied to absorber 110 may be carried out by a pressure exchanger 120 as explained below, to preserve the built up pressure while exchanging liquids in the high pressure loop.

Absorber 110 is arranged to spray the pressurized water in inject into the water compressed flue gas 81 from compressor 112. A large part of the CO₂ in the injected flue gas, e.g. over 50%, dissolves under the pressure into the sprayed water, to produce resulting water enriched with dissolved gases, mainly CO₂. System 100 utilizes the high dissolvability of CO₂ in water (ca. 1200 ppm) in respect to the dissolvability of the other flue gas constituents (e.g. O₂ ca. 10 ppm, N₂ ca. 1 ppm, at 20 bar).

The water receiving unit is connected to absorber 110 and is arranged to receive the water with dissolved flue gas therefrom and to remove dissolved CO₂ from the resulting water into an organic or a mineralized form. For example, in FIG. 2, the resulting water is removed over power exchanger (to maintain their high pressure) and dispensed to water reservoir 80 such as the sea. In the sea, dissolved CO₂ is turned into organic matter by algae, and other gas constituents may evaporate.

System 100 thus removes CO₂ from the flue gas and makes the CO₂ available for biological and mineralization processes within water reservoir 80 (such as the sea), thereby reducing CO₂ emissions of power plant 90 to the atmosphere.

Power exchanger 120 has a low pressure (LP) inlet 120A, a low pressure outlet 120B, a high pressure inlet 120C and a high pressure outlet 120D, as illustrated in FIG. 2. Power exchanger 120 is arranged to exchange fluid between a low pressure loop and a high pressure loop while maintaining the respective pressures.

Power exchanger 120 is connected to the water source, for example a cooling water source 93 (arranged to cool a condenser 92 receiving steam from a turbine 91 in power plant 90) and is arranged to receive water therefrom in low pressure inlet 120A.

Power exchanger 120 is connected to a pump 111 that is arranged to receive and pressurize the resulting water from absorber 110. Power exchanger 120 is arranged to receive the pressurized resulting water from pump 111 in high pressure inlet 120C.

Power exchanger 120 is arranged to discharge, from high pressure outlet 120D, water from low pressure inlet 120A that is pressurized by the pressurized resulting water from high pressure inlet 120C and to discharge, from low pressure outlet 120B, depressurized pressurized resulting water from high pressure inlet 120C.

Absorber 110 is connected to high pressure outlet 120D of power exchanger 120 to receive therefrom the water for spraying.

When the water fed to absorber 110 is cooling water 82 of the same plant 90 producing flue gas 81, system provides a solution for CO₂ removal and sequestration. The sea may be the source for cooling water 82 as well as the water reservoir 80 into which CO₂ enriched water is disposed for organic CO₂ utilization.

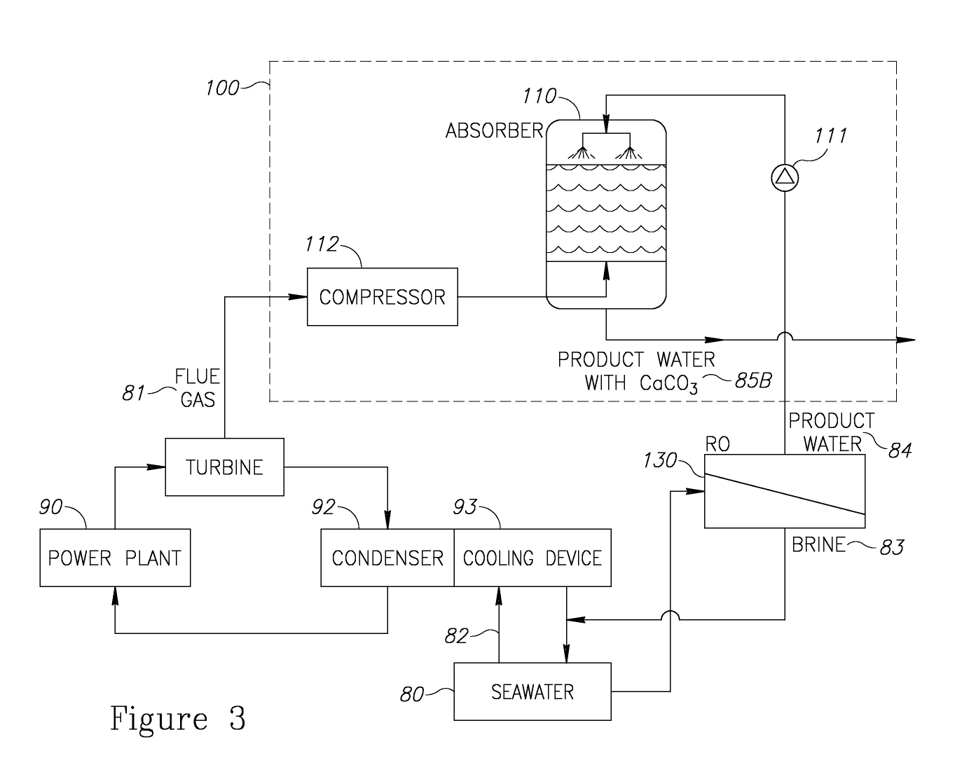

FIG. 3 is a high level schematic block diagram illustrating system 100 according to some embodiments of the invention.

System 100 comprises compressor 112, absorber 110 and a water receiving unit (depicted in FIG. 3 as the hardened product water 85B).

Compressor 112 is connected to a flue gas outlet of a plant 90 and is arranged to compress flue gas 81 obtained therefrom to a specified pressure e.g. 20 bar that allows dissolving flue gas 81 into water sprayed in absorber 110. Flue gas 81 comprises CO₂, N₂, O₂ and other gases.

Absorber 110 is connected to a water source that supplies pressurized water. The water source may comprise permeate or product water 84 from a reverse osmosis (RO) plant 130, as illustrated in FIG. 3. Product water 84 are pressurized by pump 111 before entering absorber 110, e.g. to a pressure of 20 bar.

Absorber 110 is arranged to spray the pressurized product water in inject into the water compressed flue gas 81 from compressor 112. A large part of the CO₂ in the injected flue gas, e.g. over 50%, dissolves under the pressure into the sprayed water, to produce resulting water enriched with dissolved gases, mainly CO₂. System 100 utilizes the high dissolvability of CO₂ in water (ca. 1200 ppm) in respect to the dissolvability of the other flue gas constituents (e.g. O₂ ca. 10 ppm, N2 ca. 1 ppm).

The water receiving unit is connected to absorber 110 and is arranged to receive the product water enriched with dissolved CO₂ therefrom and to mineralize the CO₂ as CaCO₃ or MgCO₃ to harden the product water.

System 100 not only removes CO₂ from flue gas 81, but also synergetically acidifies permeate 84 of RO plant 130 to spare the necessary addition of expensive liquid CO₂ (see FIG. 1).

When seawater 80 is the source of cooling water 82 for plant 90 providing flue gas 81, brine 83 from RO plant 130 may be disposed into sea 80, or mixed with disposed cooling water to reduce its salinity, hence providing a second synergy with plant 90.

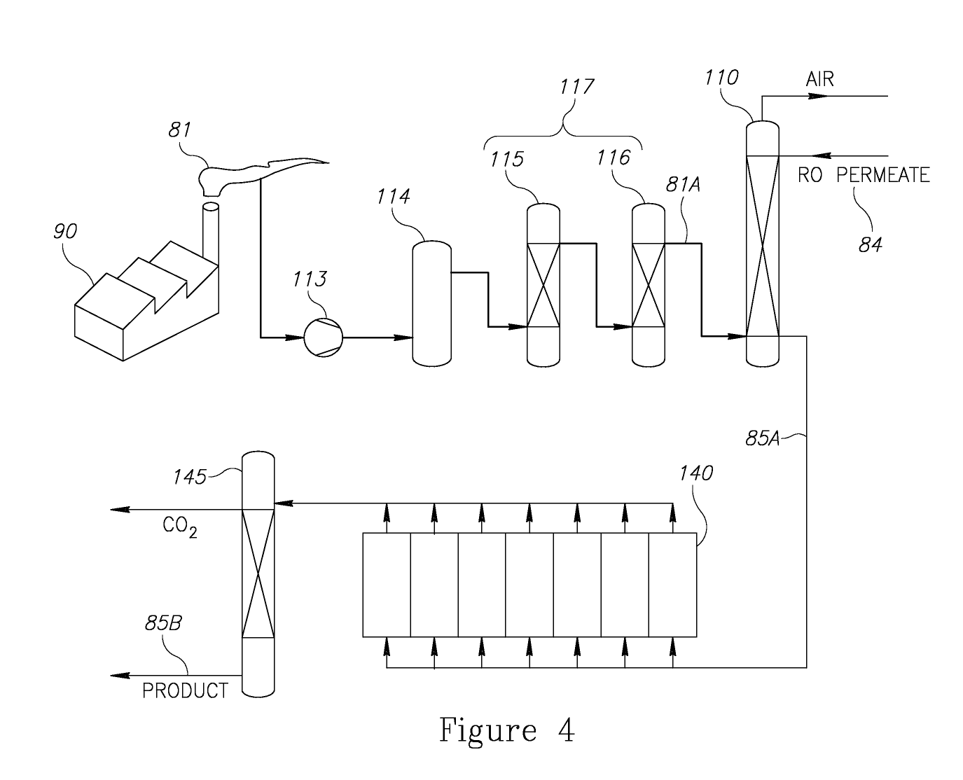

FIG. 4 is a high level schematic block diagram illustrating system 100 according to some embodiments of the invention.

System 100 comprises a cleaning unit 117 connected between compressor 112 and absorber 110 or before compressor 112 (not shown in FIG. 4).

Cleaning unit 117 is connected after a blower 113 conducting flue gas 81 (comprising e.g. 6-17% CO₂) to a direct contact cooling tower 114 for cooling. Cleaning unit 117 comprises a permanganate cleaning unit 115 arranged to bring the flue gas into gas-liquid contact with a permanganate solution, to generate a first stage treated flue gas in which all toxic gases (e.g. NO₂) are oxidized.

Cleaning unit 117 further comprises an activated carbon unit 116 arranged to bring the first stage treated flue gas into gas-solid contact with activated carbon that adsorbs organic matter from the flue gas, to generate a cleaned CO₂ in air mixture 81A. Cleaned CO₂ in air mixture 81A is dissolved in RO permeate 84 to yield acidified product 85A.

System 100 may further comprise a limestone reactor 140 connected to absorber 110, and arranged to bring received resulting CO₂ enriched product water 85A into contact with limestone, to mineralize the CO₂ to harden the product water 85B. Excess CO₂ from product water 85B may be removed in a desorber tower 145 by a stripping air stream. Residual CO₂ may be treated, returned to CO₂ in air mixture 81A or dissolved in water disposed to water reservoir 80.

In exemplary projects, power plant 90's CO₂ production of 30-56 tons CO₂ per day, may provide 19-36 ton CO₂ per day used in associated desalination plants, thereby simultaneously sequestering CO₂ from flue gas 81 and sparing the expensive addition of CO₂ in the post treatment of permeate.

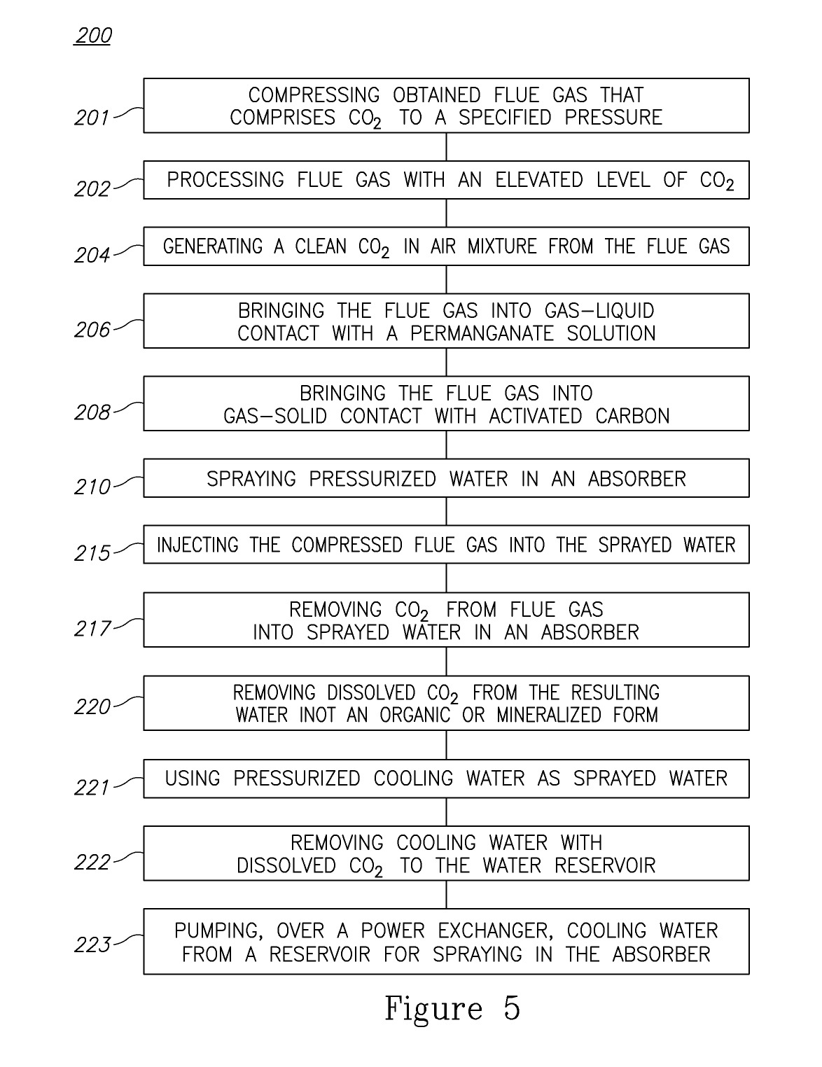

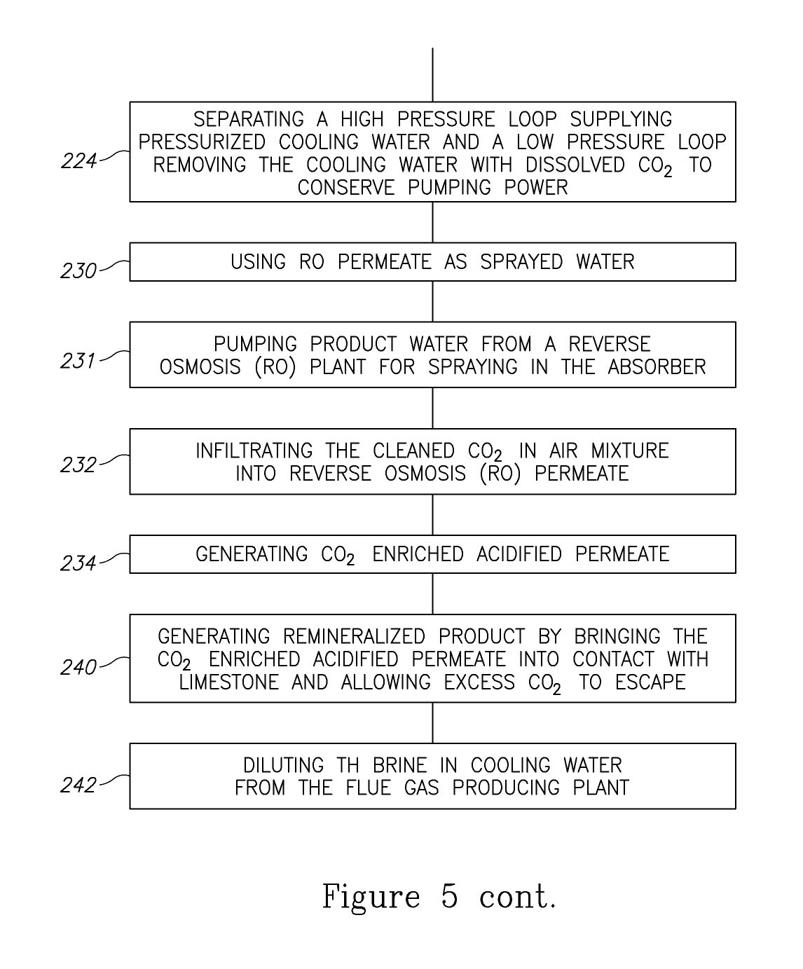

FIG. 5 is a high level flowchart illustrating a method 200 according to some embodiments of the invention.

Method 200 comprises the following stages: compressing obtained flue gas that comprises CO₂ to a specified pressure (stage 201), e.g. 20 bar, spraying pressurized water (e.g. at 20 bar) in an absorber (stage 210), injecting the compressed flue gas into the sprayed water (stage 215) to dissolve over 50% of the CO₂ in the flue gas in the resulting water (stage 217), and removing dissolved CO₂ from the resulting water into an organic or a mineralized form (stage 220).

In embodiments, method 200 comprises using pressurized cooling water as sprayed water (stage 221), and removing cooling water with dissolved CO₂ to the water reservoir (stage 222), e.g. into a reservoir in which CO₂ is consumed by algae.

In embodiments, method 200 further comprises pumping (stage 223), over a power exchanger, cooling water from a reservoir for spraying in the absorber. Removing the cooling water (stage 222) is carried out over the power exchanger and back into the reservoir. The cooling water and the flue gas may be associated with the same power plant. The reservoir may be a sea and the water seawater. The dissolved CO₂ may be consumed by algae in the sea.

Method 200 may comprise separating a high pressure loop supplying pressurized cooling water and a low pressure loop removing the cooling water with dissolved CO₂ to conserve pumping power (stage 224).

In embodiments, method 200 comprises using RO permeate as sprayed water (stage 230) by pumping (stage 231) product water from a reverse osmosis (RO) plant for spraying in the absorber (stage 210).

Method 200 may comprise processing and cleaning flue gas with an elevated level of CO₂ (stage 202) and generating a clean CO₂ in air mixture from the flue gas (stage 204) by bringing the flue gas into gas-liquid contact with a permanganate solution (stage 206) and bringing the flue gas into gas-solid contact with activated carbon (stage 208) (see FIG. 4).

In embodiments, method 200 comprises infiltrating the cleaned CO₂ in air mixture into reverse osmosis (RO) permeate (stage 232) to generate CO₂ enriched acidified permeate (stage 234) and generating remineralized product by bringing the CO₂ enriched acidified permeate into contact with limestone and allowing excess CO₂ to escape (stage 240) such that removing of dissolved CO₂ (stage 220) is carried out by mineralization to CaCO₃ to harden the product water.

Method 200 may further comprise mixing brine from the RO plant with cooling water associated with a plant producing the flue gas to dilute the brine prior to disposal (stage 242).

In the above description, an embodiment is an example or implementation of the invention. The various appearances of “one embodiment”, “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Furthermore, it is to be understood that the invention can be carried out or practiced in various ways and that the invention can be implemented in embodiments other than the ones outlined in the description above.

The invention is not limited to those diagrams or to the corresponding descriptions. For example, flow need not move through each illustrated box or state, or in exactly the same order as illustrated and described.

Meanings of technical and scientific terms used herein are to be commonly understood as by one of ordinary skill in the art to which the invention belongs, unless otherwise defined.

While the invention has been described with respect to a limited number of embodiments, these should not be construed as limitations on the scope of the invention, but rather as exemplifications of some of the preferred embodiments. Other possible variations, modifications, and applications are also within the scope of the invention.

1. A system comprising:
a compressor connected to a flue gas outlet of a plant and arranged to compress flue gas obtained therefrom to a specified pressure, the flue gas comprising CO₂,
a water source supplying pressurized water,
an absorber connected to the water source and arranged to spray water therefrom, further connected to the compressor and arranged to inject the compressed flue gas into the sprayed water to dissolve over 50% of CO₂ in the flue gas in the resulting water,
a water receiving unit connected to the absorber and arranged to receive the water with dissolved flue gas therefrom and to remove dissolved CO₂ from the resulting water into an organic or a mineralized form.

2. The system of claim 1, further comprising
a power exchanger having a low pressure inlet, a low pressure outlet, a high pressure inlet and a high pressure outlet and arranged to exchange fluid between a low pressure loop and a high pressure loop while maintaining the respective pressures, wherein:
the power exchanger is connected to the water source and is arranged to receive water in the low pressure inlet,
the power exchanger is connected to a pump that is arranged to receive and pressurize the resulting water from the absorber, the power exchanger arranged to receive the pressurized resulting water from the pump in the high pressure inlet, and
the power exchanger is arranged to discharge, from the high pressure outlet, water from the low pressure inlet that is pressurized by the pressurized resulting water from the high pressure inlet and to discharge, from the low pressure outlet, depressurized pressurized resulting water from the high pressure inlet,
wherein the absorber is connected to the high pressure outlet of the power exchanger to receive therefrom the water for spraying.

3. The system of claim 2, wherein the water source is cooling water associated with the plant that produces the flue gas.

4. The system of claim 2, wherein the depressurized resulting water are disposed to a water reservoir for organic removal of the dissolved CO₂ by algae.

5. The system of claim 4, wherein the water reservoir is a sea from which cooling water is taken.

6. The system of claim 1, further comprising a reverse osmosis (RO) plant arranged to produce, from sea water, product water at a product water outlet and brine, wherein the absorber is connected to the product water outlet to receive therefrom the water for spraying, and wherein the resulting water is CO₂ enriched product water.

7. The system of claim 6, further comprising a cleaning unit connected between the compressor and the absorber, the cleaning unit comprising:
a permanganate cleaning tank arranged to bring the flue gas into gas-liquid contact with a permanganate solution, to generate a first stage treated flue gas, and
an activated carbon container arranged to bring the first stage treated flue gas into gas-solid contact with activated carbon, to generate a cleaned CO₂ in air mixture.

8. The system of claim 6, further comprising a limestone reactor connected to the absorber, and arranged to bring received resulting CO₂ enriched product water into contact with limestone, to mineralize the CO₂ to harden the product water.

9. A method comprising:
compressing obtained flue gas that comprises CO₂ to a specified pressure,
spraying pressurized water in an absorber,
injecting the compressed flue gas into the sprayed water to dissolve over 50% of the CO₂ in the flue gas in the resulting water, and
removing dissolved CO₂ from the resulting water into an organic or a mineralized form.

10. The method of claim 9, wherein the removing is carried out into a reservoir in which CO₂ is consumed by algae.

11. The method of claim 9, further comprising pumping, over a power exchanger, cooling water from a reservoir for spraying in the absorber, and wherein the removing is carried out over the power exchanger and back into the reservoir, wherein the cooling water and the flue gas are associated with a power plant.

12. The method of claim 11, wherein the reservoir is a sea and the water is seawater, and wherein the dissolved CO₂ is consumed by algae in the sea.

13. The method of claim 9, further comprising pumping product water from a reverse osmosis (RO) plant for spraying in the absorber and wherein the removing of dissolved CO₂ is carried out by mineralization to CaCO₃ to harden the product water.

14. The method of claim 13, further comprising mixing brine from the RO plant with cooling water associated with a plant producing the flue gas to dilute the brine prior to disposal.

15. The method of claim 9, further comprising cleaning the flue gas by bringing the flue gas into gas-liquid contact with a permanganate solution and into gas-solid contact with activated carbon, to yield a cleaned CO₂ in air mixture.
